(19) United States
(12) Patent Application Publication
(10) Pub. No.: US 2006/0114934 A1
(43) Pub. Date: Jun. 1, 2006

(54) Network operation method in interactive satellite communications system

(76) Inventors: Minsu Shin, Daejeon (KR); Deock-Gil Oh, Daejeon (KR); Ho-Jin Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/193,763

(22) Filed: Jul. 28, 2005

(30) Foreign Application Priority Data
Nov. 26, 2004 (KR) 10-2004-0098180

(51) Int. Cl. H04J 3/22; H04J 3/16; H04Q 7/24; H04B 7/185

(52) U.S. Cl. 370/466; 370/316

(57) ABSTRACT

A network operation method in an interactive satellite communications system interworking with an external network without modifying a network setting is provided. The network operation method in a base station of the interactive satellite communications system includes the steps of: receiving a data request packet from a user; converting a private internet protocol (IP) address of the user into a public IP address; transmitting the data request packet to an external server; receiving a response packet to the data request packet from the external server and converting the converted public IP address into the private IP address; and transmitting the received response packet to the user by using information on a mapping table.

### FIELD OF THE INVENTION

The present invention relates to a network operation method in an interactive satellite communications system; and, more particularly, to a network operation method that enables different types of networks to interwork with each other through setting a router of a base station to interwork with an external network without changing internet protocol (IP) addresses of the base station and a plurality of terminal stations and network settings when the base station and the terminal stations are established to provide a new service in an interactive satellite communications system including one base station, the plurality of terminal stations and a plurality of personal computer (PC) users.

### DESCRIPTION OF THE RELATED ART

In general, a base station and a terminal station of an interactive satellite communications system use public IP addresses without employing an additional address conversion technique. Therefore, when the base station and the terminal station are newly established, pieces of network information of all systems need to be modified depending on locations where the base station and the terminal station are established. However, these serial processes of using public IP addresses and modifying related network information along with an initial operation test take a long time, and there may be another problem in that an additional public IP address needs to be allocated. Furthermore, as the number of terminal stations increases, the maintenance fee increases, and in the case that the terminal stations are not separated from the existing network, performance of the system may be affected. Accordingly, it is highly required to develop a method of providing an independent network service that does not affect an interworking terrestrial network when the base station and terminal stations are newly established.

### SUMMARY OF THE INVENTION

It is, therefore, an object of the present invention to provide a network operation method in an interactive satellite communications system capable of interworking with an external network without modifying a network setting through arranging a terminal station to use an allocated range of private IP addresses connected with a media access control (MAC) address of the terminal station and a base station to transmit data via reciprocal conversions between a public IP address and a private IP address.

In accordance with an aspect of the present invention, there is provided a method for operating a network in a base station of a satellite communications system, including the steps of: receiving a data request packet from a user; converting a private internet protocol (IP) address of the user into a public IP address; transmitting the data request packet to an external server; receiving a response packet to the data request packet from the external server and converting the converted public IP address into the private IP address; and transmitting the received response packet to the user by using information on a mapping table.

### BRIEF DESCRIPTION OF THE DRAWINGS

The above and other objects and features of the present invention will become apparent from the following description of the preferred embodiments given in conjunction with the accompanying drawings, in which:

FIG. 1 is a configuration diagram showing a satellite communications system to which the present invention is applied;

FIG. 2 is a diagram showing one embodied network operation procedure in an interactive satellite communications system in accordance with the present invention;

FIG. 3 is a diagram showing another embodied network operation procedure in an interactive satellite communications system in accordance with the present invention; and

FIG. 4 is a flowchart describing a network operation method in an interactive satellite communications system in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

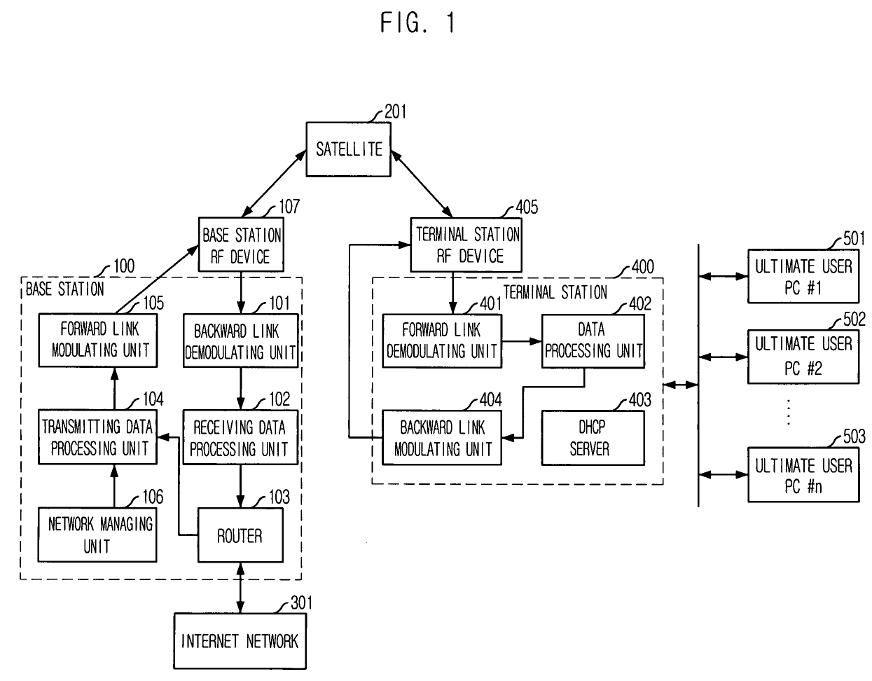

FIG. 1 is a configuration diagram showing a satellite communication system to which the present invention is applied.

Referring to FIG. 1, the satellite communications system includes: a base station 100; a base station radio frequency (RF) device 107; a satellite 201; a terminal station 400; a terminal station RF device 405; an internet network 301; and a first to an nth ultimate personal computer (PC) users 501 to 503.

The base station 100 includes: a backward link demodulating unit 101; a receiving data processing unit 102; a router 103; a transmitting data processing unit 104; a forward link modulating unit 105; and a network managing unit 106. The backward link demodulating unit 101 receives a signal transmitted from the terminal station 400 through the base station RF device 107 and converts the received signal into a baseband signal via demodulation and channel decoding. After the signal conversion, the backward link demodulating unit 101 outputs the baseband signal to the receiving data processing unit 102.

Next, among the received data through the backward link demodulating unit 101, the receiving data processing unit 102 outputs a traffic data to the router 103. Then, the router 103 transmits the received traffic data to the external internet network 301 and receives data requested by a user from the external internet network 301.

The transmitting data processing unit 104 receives data requested by the user from the router 103 and encapsulates the received data via multi-protocol encapsulation (MPE) method defined in a digital video broadcasting (DVB) data broadcasting standard for the purpose of transmitting the received data to the user. At this time, the encapsulation of the received data utilizes an IP address allocated to the user and a hardware address of the terminal 400. Afterwards, the transmitting data processing unit 104 converts the encapsulated data into a moving picture experts group (MPEG)-2 transport stream (TS) packet. Also, the transmitting data processing unit 104 receives information from the network managing unit 106 and searches for a MAC address of the terminal station 400 corresponding to a destination address of the received MPEG-2 TS packet.

In case of a service subscription, the network managing unit 106 checks an available network resource and allocates a necessary resource and, transmits the network information of the subscribed terminal stations 400 to the transmitting data processing unit 104, so that the transmitting data processing unit 104 can use the network information when the user request data is transmitted through the satellite 201. Then, the forward link modulating unit 105 receives the traffic data from the transmitting data processing unit 104 and performs a modulation and channel decoding activity with respect to the received traffic data, thereby outputting the channel decoded data to the base station RF device 107.

Meanwhile, the terminal station 400 includes: a forward link demodulating unit 401; a data processing unit 402; a dynamic host configuration protocol (DHCP) server 403; and a backward link modulating unit 404.

The forward link demodulating unit 401 receives a signal transmitted from the base station 100 through the terminal station RF device 405 and demodulates the received signal, which is, in turn, subjected to a channel decoding activity. Afterwards, the channel decoded signal is outputted to the data processing unit 402.

Next, the data processing unit 402 classifies the outputted signal from the forward link demodulating unit 401 into a control data and a traffic data and manages network environments related to the first to the nth ultimate users 501 to 503. Also, the data processing unit 402 converts a transport layer data type of the receiving/transmitting data.

Also, the DHCP server 403 allocates a range of private IP addresses allocated by the base station 100 upon requests from the first to the nth ultimate users 501 to 503. That is, the DHCP server 403 performs a dynamic IP address allocation function.

The backward link modulating unit 404 converts the IP-based user data outputted from the data processing unit 402 into an asynchronous transfer mode (ATM) cell or a MPEG-TS packet. Afterwards, the backward link modulating unit 404 modulates the converted packet and performs a channel decoding activity with respect to the modulated packet, thereby outputting the channel-decoded packet to the terminal station RF device 405.

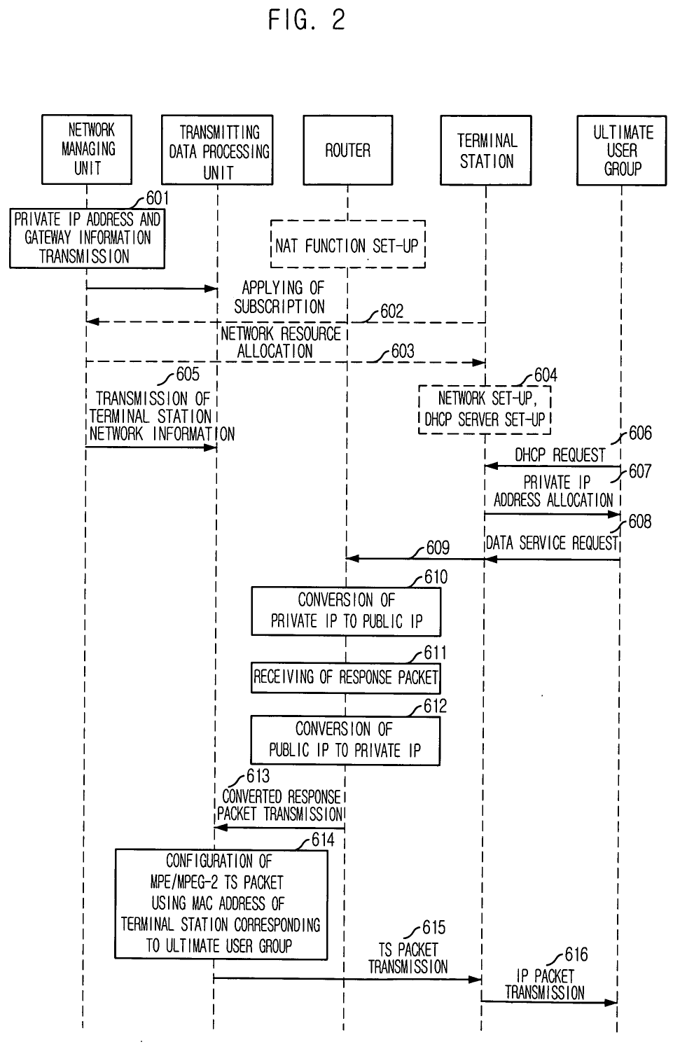

FIG. 2 is a diagram showing one embodied network operation procedure in an interactive satellite communications system in accordance with the present invention.

At step 601, during an initial system setting, the network managing unit 106 transmits a private IP address and gateway information to those configuration elements of the base station 100 except for the transmitting data processing unit 104 and the router 103. At this time, the router 103 should have a network address translation (NAT) function for the private IP addresses and public IP addresses with respect to receiving data and transmitting data.

After the initial system setting is completed, if a service subscription is taken place via off-line from the terminal station 400, at step 602, a base station manager receives information on a MAC address of the terminal station 400 from the terminal station 400 and then, sets the MAC address information in the network managing unit 106.

Afterwards, at step 603, the base station manager provides the terminal station 400 with a private IP address to be used at the corresponding terminal station 400, a gateway address, and a range of private IP addresses that can be allocated to an ultimate user group including the users 501 to 503. That is, the base station manager allocates the network resources.

At step 604, the terminal station 400 sets network information of the terminal station 400 by using the above allocation information provided from the network managing unit 106. Also, the terminal station 400 sets the DHCP server 403.

Meanwhile, at step 605, the base station manager arranges the terminal station information set at the terminal station 400 in the form of a mapping table and, sets this mapping table at the network managing unit 106. At this time, the terminal station information includes the MAC address of the terminal station 400 and the range of private IP addresses to be used by the ultimate user group. Then, the network managing unit 106 transmits such set information to the transmitting data processing unit 104. That is, the network managing unit 106 transmits the network information of the terminal station 400 to the transmitting data processing unit 104.

At step 606, when one of the first to the nth ultimate users 501 to 503 makes a DHCP request to the terminal station 400 in the state that the terminal station 400 and the base station 100 are set completely as described above, then, the DHCP server 403 of the terminal station 400 transmits the private IP address selected from the allocated range of private IP addresses and the network setting information to said one of the first to the nth ultimate users 501 to 503 at step 607.

Subsequently, said one ultimate user 501, 502 or 503 completes the network setting of the ultimate user himself/herself 501, 502 or 503 by using the provided private IP address and network setting information and, transmits a data service request packet to the terminal station 400 at step 608.

The terminal station 400, then, transmits the data service request packet to the router 103 of the base station 100 at step 609. Afterwards, at step 610, the router 103 converts the private IP address of said one ultimate user 501, 502 or 503 included in the data service request packet into a public IP address and then, forwards the converted public IP address to the internet network 103.

Next, at step 611, the router 103 receives a data service response packet from an external server of the internet network 301 and, at step 612, the router 103 converts the public IP address included in the data service response packet into the originally allocated private IP address. Afterwards, the router 103 transmits the data service response packet including the converted private IP address to the transmitting data processing unit 104 at step 613.

The transmitting data processing unit 104 receives the converted data service response packet, which is an IP packet, and converts this IP packet, into a MPE/MPEG-TS packet at step 614. At this time, this conversion is carried out by using the mapping table transmitted from the network managing unit 106 to the transmitting data processing unit 104. Afterwards, at step 615, the transmitting data processing unit 104 transmits the converted MPE/MPEG-TS packet to the corresponding terminal station 400.

At step 616, the terminal station 400 converts the received MPE/MPEG-TS packet into the IP packet and transmits the converted IP packet to said ultimate user 501, 502 or 503 through a hub.

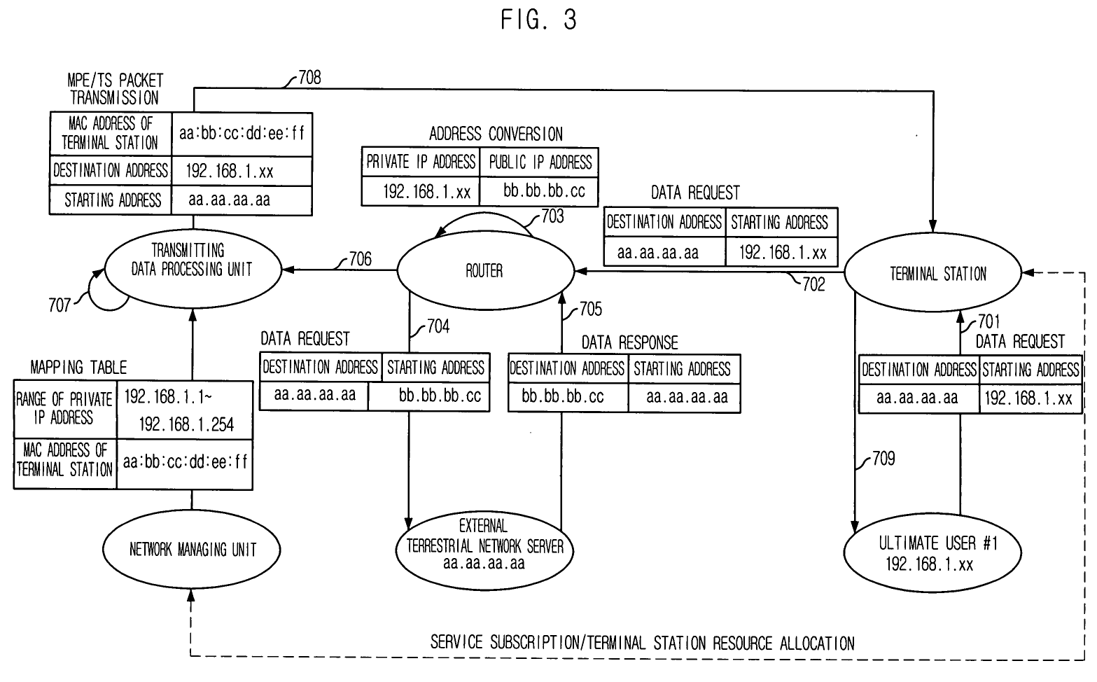

FIG. 3 is a diagram showing another embodied network operation procedure in an interactive satellite communications system in accordance with the present invention.

Prior to providing a service, the terminal station 400 makes a subscription to the service via off-line. At this time, the terminal station 400 provides information on a MAC address of the terminal station 400, and a base station manager allocates a private IP address, a gateway address and a range of private IP addresses for the first to the nth ultimate users 501 to 503. Also, the base station manager registers this allocation information to the network managing unit 106.

The terminal station 400 sets network environments of the terminal station 400 and the DHCP server 403 with use of the allocation information, while the network managing unit 106 transmits mapping information on the MAC address aa:bb:cc:dd:ee:ff of the terminal station 400 and the range of private IP addresses 192.168.1.1 to 192.168.1.254 to be allocated to the first to the nth ultimate users 501 to 503 to the transmitting data processing unit 104.

After the above initial setting is completed, it is assumed that the private IP address of 192.168.1.xx is allocated to the first ultimate user 501 as per the request made by the first ultimate user 501.

As shown in FIG. 3, at step 701, the first ultimate user 501 makes a data request to the terminal station 400 to receive a service. At this time, a destination address of an IP packet is ‘aa.aa.aa.aa,’ which is an external server address to be connected and, a starting address of the IP packet is ‘192.168.1.xx’ of the IP packet.

Next, at step 702, the terminal station 400 routes the received IP packet to the base station 100, and then, at step 703, the private IP address of the IP packet received at the router 103 of the base station 100, that is, ‘192.168.1.xx,’ is converted into a public IP address, ‘bb.bb.bb.cc.’ That is, the starting address is converted into the public IP address.

At step 704, the IP packet of which starting address is converted into the public IP address is transmitted to an external server whose address is ‘aa.aa.aa.aa.’ Afterwards, at step 705, the external server transmits a response packet corresponding to the converted IP packet.

Then, the step 703 is performed again by converting the public IP address of the transmitted response packet into the private IP address at the router 103 of the base station 100. The response packet converted into the private IP address is subsequently transmitted to the transmitting data processing unit 104 at step 706.

At step 707, the transmitting data processing unit 104 identifies to which terminal station the response packet is transmitted by using the mapping table information inputted from the network managing unit 106. The identification takes place through the MAC address of the selected terminal station necessary for configuring a MPE type for satellite transmission of IP datagram in digital video broadcasting (DVB)-S standards.

The response data configured with the MPE section is divided into a MPEG-TS packet and transmitted to the corresponding terminal station 400 via satellite transmission at step 708. Then, at step 709, the terminal station 400 transmits the MPEG-TS packet to the first ultimate user 501 corresponding to the converted IP address.

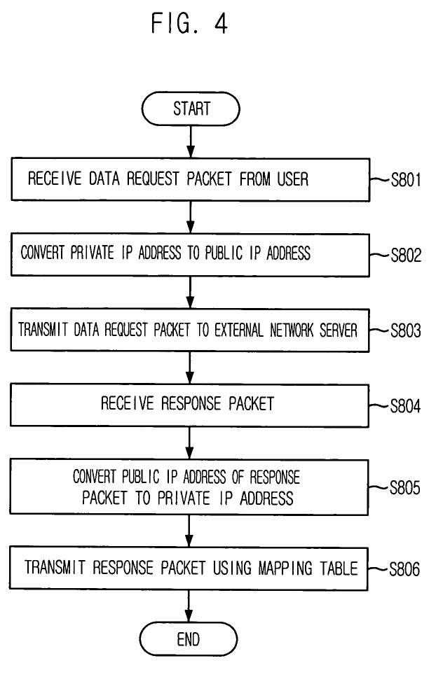

FIG. 4 is a flowchart describing a network operation method in an interactive satellite communications system in accordance with the present invention.

As shown, at step 801, a data request packet is inputted by a user. At this time, the data request packet includes a destination address and a starting address.

Next, at step 802, a private IP address included into the received data request packet, that is, the starting address, is converted into a public IP address and, at step 803, the data request packet is transmitted to an external server.

Then, the external server inputs a response packet to the data request packet at step 804, and the converted public IP address is converted into the private IP address again at step 805. That is, the public IP address is converted into the original starting address.

With use of the previously provided mapping table information, at step 806, the received response packet is transmitted to the user. At this time, the mapping table information includes a MAC address of a terminal station and a range of private IP addresses. Therefore, the received response packet is transmitted to the MAC address of the terminal station corresponding to the converted original starting address.

The above described network operation method, which is implemented in the form of a program can be recorded into a computer readable recording medium such as a read-only memory (ROM), a random access memory (RAM), a compact disc (CD)-ROM, a floppy disk, a hard disk, a magnetic disk and so forth. Since the recordation procedure can be easily derivable by those ordinary people skilled in the art, detailed description of such recordation procedure will be omitted.

According to the present invention, it is possible to effectively use network resources and to reduce time and costs for re-configuring a system required for providing a new service. Also, there is another effect of providing a service without being affected by a previously set network configuration during the interworking of the interactive satellite communications system with a terrestrial network.

The present application contains subject matter related to Korean patent application No. 2004-0098180, filed with the Korean Intellectual Property Office on Nov. 26, 2004, the entire contents of which is incorporated herein by reference.

While the present invention has been described with respect to the particular embodiments, it will be apparent to those skilled in the art that various changes and modifications may be made without departing from the scope of the invention as defined in the following claims.

What is claimed is:

1. A method for operating a network in a base station of a satellite communications system, comprising the steps of:
receiving a data request packet from a user;
converting a private internet protocol (IP) address of the user into a public IP address;
transmitting the data request packet to an external server;
receiving a response packet to the data request packet from the external server and converting the converted public IP address into the private IP address; and
transmitting the received response packet to the user by using information on a mapping table.

2. The method as recited in claim 1, wherein the receiving of the data request packet is carried out through a terminal station and the terminal station is allocated with a private IP address of the terminal station, a gateway address and a range of private IP addresses to be allocated to the user from the base station.

3. The method as recited in claim 2, wherein the information on the mapping table includes a media access control address of the terminal station and the range of private IP addresses to be allocated to the user.

4. The method as recited in claim 3, wherein the transmitting of the response packet to the user is carried out by converting the received response packet into a multi-protocol encapsulation (MPE)/moving picture experts group (MPEG)-transport stream (TS) packet by using the information on the mapping table and transmitting the converted MPE/MPEG-TS packet to the user through the terminal station.
